(19) United States
(12) Patent Application Publication
(10) Pub. No.: US 2015/0210833 A1
(43) Pub. Date: Jul. 30, 2015

(54) NOVEL THERMOPROTECTIONS OBTAINED BY A FILAMENT WINDING PROCESS AND USE THEREOF

(71) Applicants: Nicolas Rumeau, St Medard en Jalles (FR); Alain Champmartin, St Medard en Jalles (FR); Christian Freydier, St Medard en Jalles (FR)

(72) Inventors: Nicolas Rumeau, St Medard en Jalles (FR); Alain Champmartin, St Medard en Jalles (FR); Christian Freydier, St Medard en Jalles (FR)

(73) Assignee: ROXEL FRANCE, Saint Medard en Jalles (FR)

(21) Appl. No.: 14/115,829

(22) PCT Filed: May 4, 2012
(86) PCT No.: PCT/EP2012/058301

§ 371 Date: Jul. 17, 2014

(30) Foreign Application Priority Data
May 6, 2011 (FR) 1153896

(51) Int. Cl. C08K 7/10; C08K 3/34; B29C 70/30

(52) U.S. Cl. CPC C08K 7/10; B29C 70/30; C08K 3/34; B29K 2065/00; B29K 2307/04

(57) ABSTRACT

A novel composite material is obtained by winding a reinforcing yarn, made of refractory fibers, onto a form, and a mandrel, the wound yarn being impregnated, as it is wound, with a “slip” composed of a liquid resin mixed with fillers composed of particles of refractory material. The reinforcing yarn is composed of linear fibers and of fibers forming protruding loops which confer a three-dimensional texture on the wound reinforcement. The yarn preform composed of the reinforcing yarn impregnated with “slip” is crosslinked according to a defined heating cycle comprising several temperature gradients of different durations. The crosslinked yarn preform is subsequently machined so as to bring the composite material component thus produced to the desired shape. The composite material component thus shaped can optionally be reinforced by overwinding on its external face with a reinforcing yarn preimpregnated with a resin chemically compatible with the resin constituting the material.

The present invention relates to the general field of composite materials and more particularly that of the preparation of composite materials intended to form coatings which are refractory toward heat. It relates more particularly to the preparation, by the filament winding technique, of fibrous composite materials comprising an organic matrix reinforced by particles of refractory materials, such as ceramics, for example.

The search in the aeronautical field for enhanced performances in terms of propulsion, the search brought about by the increase in the complexity and duration of the flights carried out by different vehicles, brings about either an increase in the operating life of the thrusters equipping the vehicle under consideration or a tightening in the conditions for combustion (pressure, temperature) of the fuel, for example of the solid propellant. This tightening in the operating conditions requires that the thermomechanical performances of the components making up the thrusters, such as the heat-shield coating for the combustion chamber or its subassemblies, including extension tube and nozzle divergent, be improved.

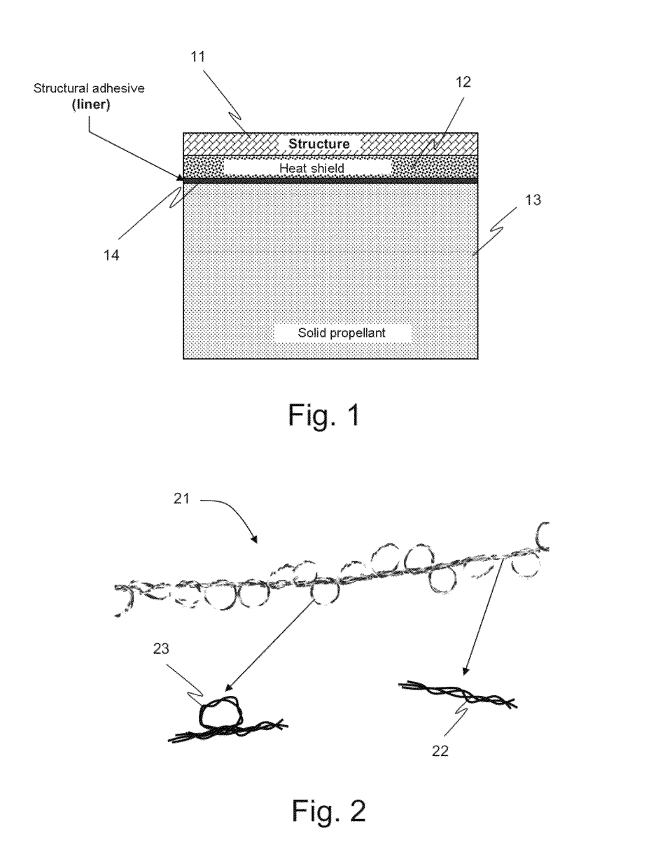

During recent years, the function of heat shielding the combustion chambers of solid propellant engines has been mainly provided by the use of elastomeric or composite materials composed of an organic matrix within which mechanical reinforcements and refractory and endothermic fillers are simultaneously incorporated. FIG. 1 gives a diagrammatic representation of the structure of a solid propellant engine, the internal wall 11 of which is covered with a heat-shield coating 12 placed between the wall and the fuel 13, the coating being separated from the fuel by a layer of structural material ensuring notably the adhesion of the propellant, a layer also known as “liner”.

The main object of the heat shield thus prepared is to control the mechanical stresses and then the heat flow imposed on the thruster body during the phase of combustion of the solid propellant. The heat shield is thus normally designed in order to ensure the shielding of the structural materials of the thruster during the operation thereof, in particular when the operation is very lengthy. Furthermore, it is designed so as not to interfere with the operation of the thruster.

Consequently, such a heat shield should generally exhibit the following technical characteristics:

chemical and pyrotechnical compatibility with the energetic materials (propellant) constituting the charge of the engine, the combustion gases and the particles (chemical entities) produced during operation;

excellent mechanical strength, guaranteeing in particular the required reliability relating to the operation of the thruster,

excellent resistance to the thermal shocks which occur during the phases of transportation and storage in particular and to high temperatures during the phases of operation,

resistance to the erosion generated by the circulation of the combustion gases during operation,

limitation of the heat flow transmitted toward the structural materials, such as the external structure of the thruster.

In order to produce a coating exhibiting these characteristics, it is known to use elastomeric materials, generally comprising, as fillers, mechanical reinforcements and refractory fillers.

It is thus known to produce heat-shielding components from a silicone (Poly-Di-Methyl-Siloxane) matrix, within which have been incorporated short carbon fibers and also refractory fillers of the silicon carbide type, this combination conferring, on the shield thus produced, properties forming an excellent compromise as regards to the attainment of the abovementioned characteristics.

The advantage of the shield thus produced lies in the fact that the use of a silicone matrix makes it possible to simultaneously ensure, over a broad temperature range, excellent mechanical characteristics of the shield, resulting from a high elongation capability, good adhesion to the wall of the thruster, in return, however, for carrying out beforehand a suitable surface treatment, and also a satisfactory thermal stability and good behavior and significant resistance in an oxidizing atmosphere.

In order to produce a coating exhibiting such characteristics, it is also known to proceed by winding fibers onto a mandrel having an appropriate diameter, the mandrel exhibiting spikes positioned perpendicularly to its surface, the fibers being impregnated beforehand, within a slip, with an organic resin acting as matrix in the final material. Such a process, better known to a person skilled in the art under the acronym “BRAS”, makes it possible to produce a coating exhibiting a multidirectional texture (3D texture in the present case) which confers, on the heat shield thus prepared, better mechanical performances in the longitudinal direction and a very good overall behavior of the cinders produced during the combustion. However, it exhibits the disadvantage of being complex and lengthy to carry out, which makes it expensive to produce the coating.

One aim of the invention is to provide a solution for producing novel heat shields comprising an organic matrix reinforced by ceramic particles and a wound fibrous reinforcement, the final forming of which can be obtained by carrying out a simplified filament winding process, conferring, however, a multidirectional texture on the wound material.

To this end, a subject matter of the invention is a composition for producing a composite material and a process for producing said composite material by means of the composition.

According to the invention, the composite material is formed by crosslinking a thermosetting organic matrix impregnated into a reinforcement composed of mineral fibers or ceramic fibers, the matrix being predominantly composed of a liquid resin to which refractory reinforcing fillers are added.

The fibrous reinforcement is composed of a yarn exhibiting, over its entire length, fibers forming protruding loops. It is produced by winding the yarn onto a mandrel of appropriate diameter and appropriate shape and by impregnating the wound yarn with organic matrix, so as to form a wound preform impregnated with organic matrix exhibiting the desired final geometry. The wound preform is subsequently crosslinked in an oven so as to form the composite material. The winding of the preform is carried out so that, in view of the composition of the organic matrix and of the nature and constitution of the yarn forming the fibrous reinforcement, the organic matrix and the fibrous reinforcement are present in the material obtained, after crosslinking in an oven, in the following proportions by volume:

between 65% and 75% of organic matrix,

between 25% and 35% of fibrous reinforcement.

The composition according to the invention thus comprises a thermosetting organic matrix composed of a liquid resin comprising refractory particles as filler and also a fibrous reinforcement composed of a yarn formed of fibers, some fibers forming protruding loops over the entire length of the yarn, the thermosetting organic matrix impregnating the fibrous reinforcement.

According to a preferred embodiment, the fibrous reinforcement is composed of silica (SiO₂) or silicon carbide (SiC) fibers.

According to another preferred embodiment, the fibrous reinforcement made of silica exhibits a number of loops per linear meter of between 140 and 200.

According to a specific implementational characteristic, the loops of the fibrous reinforcement exhibit a mean diameter of 5 mm.

According to the invention, the filler-comprising organic matrix is a mixture comprising an aqueous phenolic resin and refractory particles, the proportions by weight between the phenolic resin and the refractory fillers being within the following ranges:

40 to 60% of phenolic resin;

60 to 40% of refractory fillers.

According to a preferred embodiment, the filler-comprising organic matrix comprises, by weight, 50% of phenolic resin and 50% of refractory filler.

According to a specific implementational characteristic, the phenolic resin is a liquid resin of resol type.

According to another specific implementational characteristic, the refractory fillers are composed of silicon carbide.

According to a preferred embodiment, the refractory fillers made of silicon carbide are of substantially spherical shape and exhibit a mean diameter of between 12 μm and 20 μm.

According to a specific embodiment, the silicon carbide comprises boron as flux.

According to a specific embodiment, the filler-comprising organic matrix is a mixture comprising a resin and refractory particles, the resin being a silicone oil for which the method of polymerization is of the polyaddition type.

The process according to the invention is carried out when the machinery and starting materials have been brought beforehand to an ambient temperature of between 20° C. and 30° C. It comprises mainly the following stages:

a first stage of producing the mixture, or “slip”, between the resin and the refractory filler, the mixture being produced at ambient temperature;

a second stage of filament winding, during which stage the fibrous reinforcement of yarn structure is wound, according to a preestablished winding cycle, onto the rotating mandrel while it is impregnated with the “slip”, the deposition of the “slip” being carried out continuously. The winding, carried out at ambient temperature, produces a preform made of wound yarn, which preform is impregnated with slip;

a third stage of crosslinking the preform impregnated with “slip”, the crosslinking being carried out according to a sequence of cycles of rise in temperature producing a gradual increase in the temperature of the material. The third stage is terminated by a phase during which the crosslinked material is allowed to return, of its own accord, to ambient temperature;

a fourth stage of dry machining which makes it possible both to release the crosslinked part from the mandrel and to obtain the dimensions desired for the composite material component.

According to a preferred embodiment of the process according to the invention, the machinery and the starting materials are brought to ambient temperature and are maintained at this temperature for a minimum stabilization time of approximately 20 hours.

According to a preferred embodiment, the first stage is carried out by means of a turbine mixer configured in order to obtain a resin/refractory fillers mixture for which the Brookfield viscosity is on between 8000 mPa·s and 11 000 mPa·s.

According to the invention, the deposition of the “slip” on the wound yarn reinforcement is carried out continuously and in excess by means of a peristaltic pump connected to a tank containing the prepared “slip”.

According to a specific characteristic of the process according to the invention, the spreading of the “slip” at the surface of the wound yarn reinforcement is associated with the application of a gentle pressure by means of a brush.

According to a preferred embodiment of the process according to the invention, the second stage of filament winding comprises the following preliminary operations:

preparation of the winder and positioning of the mandrel and spools of fibrous reinforcement;

adjusting the tension yarn forming the fibrous reinforcement, to a value which makes it possible to ensure the draining of the yarn reinforcement during winding so as to remove the slip deposited in excess on the yarn reinforcement, without risk of breaking the yarn reinforcement;

adjusting the maximum winding rate to a value which makes possible complete impregnation of the wound reinforcement by the “slip”.

According to a preferred embodiment, the tension applied to the yarn reinforcement is between 1.4 and 1.8 daN and the rotational speed of the mandrel is approximately 32 revolutions per minute.

According to a specific characteristic of the process according to the invention, the tension applied to the yarn reinforcement (21) is 1.6 daN.

According to the invention, the excess “slip” recovered by the draining resulting from the tension applied to the yarn constituting the yarn reinforcement is reintroduced into the “slip” tank.

According to a preferred embodiment of the process according to the invention, the third stage of temperature crosslinking the yarn preform is carried out according to the following cycle:

application of a first temperature gradient of between 20° C.±5° C. and 60° C.±5° C. during the first 2 hours±5 min;

application of a second temperature gradient of between 60° C.±5° C. and 120° C.±5° C. for the following 42 hours±5 min;

application of a third temperature gradient of between 120° C.±5° C. and 140° C.±5° C. over a period of time of 23 hours±5 min;

maintenance at the stabilization temperature of 140° C.±5° C. for 2 hours±5 min;

return to ambient temperature according to the natural inertia cycle of the material.

The third stage is carried out while the yarn preform is kept rotating on the mandrel.

According to a specific embodiment, the process according to the invention also comprises an additional stage of overwinding.

According to a specific characteristic, the overwound material employed is composed of a yarn of organic fibers which is preimpregnated with a resin chemically compatible with that employed to produce the composite material proper.

According to another specific characteristic, the overwound material employed is composed of a yarn of carbon fibers which is preimpregnated with a phenolic resin.

The invention advantageously makes it possible to produce a coating which meets ever increasing requirements in terms of mechanical and thermal performances, by combining with a specific material formulation and preparation process making it possible to obtain in an advantageously simple way a multidirectional reinforcement texture.

The characteristics and advantages of the invention will be better appreciated by virtue of the description which follows, which description is based on the appended figures, which represent:

FIG. 1, an illustration exhibiting the arrangement of the various components housed inside a thruster body;

FIG. 2, an illustration exhibiting the structure of the yarn constituting the fibrous reinforcement participating in the composition of the composite material according to the invention;

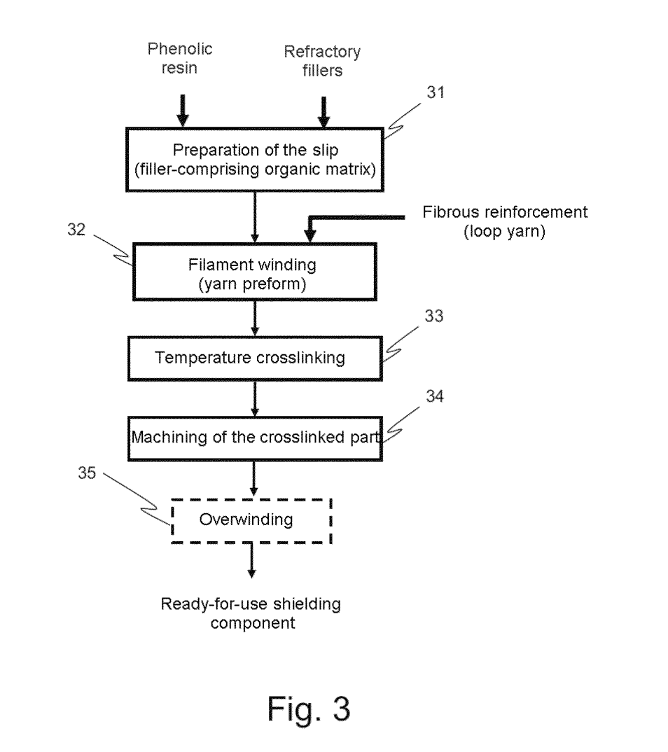

FIG. 3, the flow diagram of the various stages of the process for producing the composite material according to the invention;

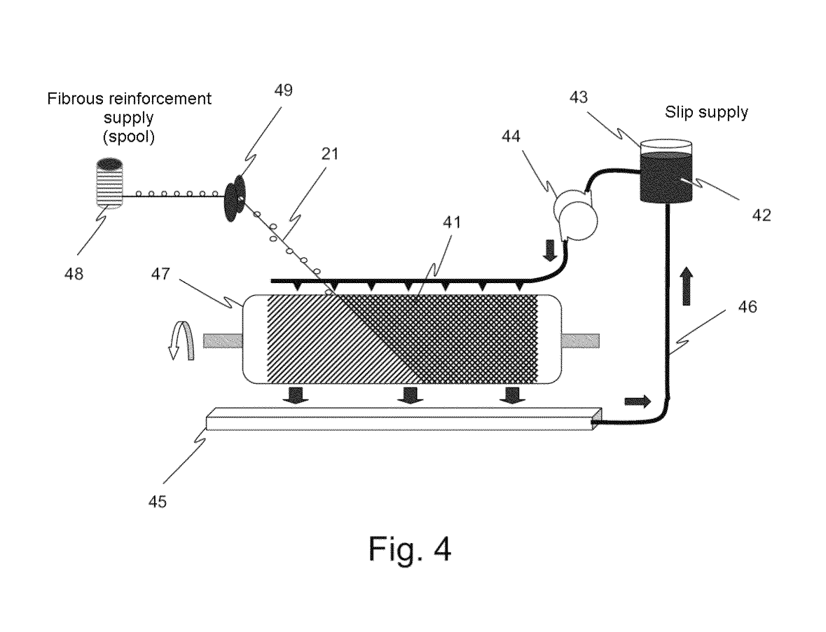

FIG. 4, an illustration of the implementation of the process for the manufacture of the composite material according to the invention;

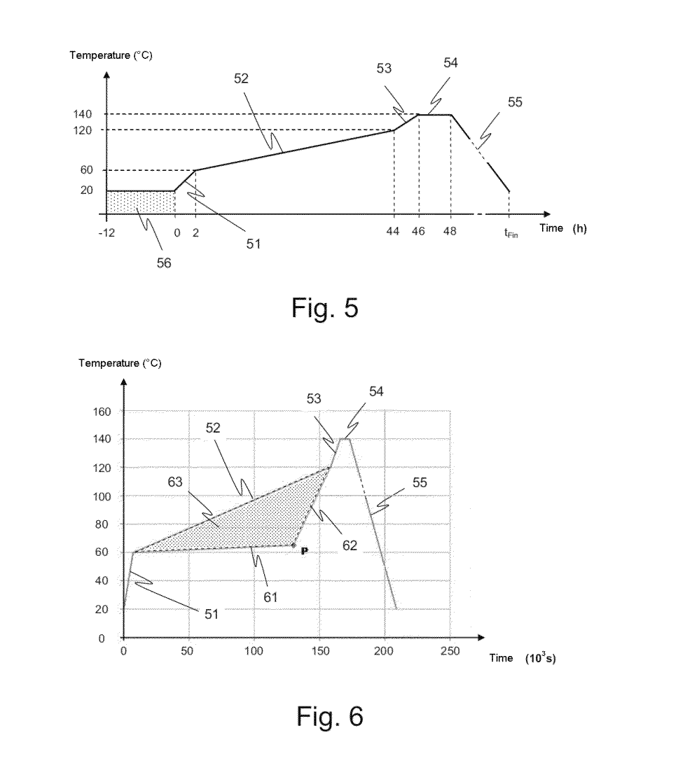

FIG. 5, an overall timing diagram describing the various phases of the crosslinking stage of the process for the manufacture of the composite material according to the invention;

FIG. 6, a partial timing diagram describing the various ways of carrying out the second phase of the crosslinking stage;

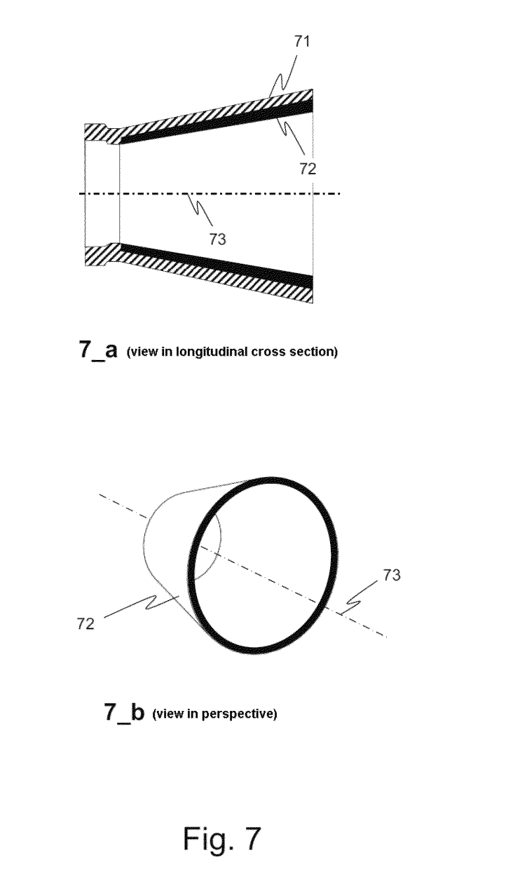

FIG. 7, the illustration of an example of a shielding component which can be made of composite material according to the invention.

The invention described below makes it possible to meet the requirement for enhancement of the mechanical and thermal performances of the shielding coatings with which a thruster may be equipped. It combines the use of a specific composition of components and a process for producing the composite material which is advantageously simple, making it possible, however, to obtain a multidirectional texture reinforcement.

The material according to the invention is produced from a composition which comprises mainly an organic matrix filled and reinforced with a fibrous reinforcement composed of mineral or ceramic fibers.

The organic matrix is preferably composed of an (aqueous) phenolic resin. Such a resin, having a low molecular weight, which generally requires crosslinking at a high temperature, of the order of approximately one hundred degrees centigrade, exhibits the advantage of providing the composite material thus formulated with excellent thermal resistance. This is because the exposure to heat of such a resin produces, by a highly endothermic chemical transformation process, a shielding carbon-based (coke) layer which obstructs the progression of this heat and reinforces the thermal and mechanical strength of the material. In addition, on being burnt, such a resin advantageously does not produce toxic fumes.

In a preferred embodiment of the invention, the organic matrix is composed of resin of resol type (liquid phenolic resin) exhibiting the characteristic of generating a level of pyrolysis residues of greater than or equal to 50%. Such a resin corresponds, for example, to the resin variety RA101 manufactured by Rhodia.

In an alternative embodiment, the organic matrix can consist of a polymeric resin of silicone resin type functioning with regard to a method of polymerization of polyaddition type which also ensures a pyrolysis residue of greater than 50%. Different types of silicone oils to which a certain percentage of fillers is added can thus be used to constitute the organic matrix. Thus, for example, the organic matrix can consist of a polydimethylsiloxane (PDMS) resin and more particularly of a resin of RTV 630 type sold by General Electric, which exhibits a thixotropic nature obtained by introduction of fillers (RTV being the acronym for Room Temperature Vulcanization).

This alternative embodiment is in particular well suited to the preparation of bulk coating components, which preparation requires control of the process of crosslinking the resin over longer time intervals. The filler-comprising silicone resin is then combined with a retarder of PT67 type sold by Wacker Chemie, which slows down the process of crosslinking the resin.

According to the invention, the organic matrix comprises a given proportion of particles of refractory material, for example of ceramic. These particles advantageously contribute to conferring, on the matrix, not only a temperature stability but also an ability to delay the progression of the heat transfer during the duration of exposure to a high temperature.

The organic matrix, thus formed of a resin/refractory filler mixture, is also referred to as slip in the context of the process for producing the composite material.

The material constituting the refractory fillers which are employed in the context of the invention is preferably silicon carbide, optionally combined with a flux, such as boron, for example. However, materials of the Al₂O₃, SiO₂ or ZrO₂ type, although being less effective thermally, can also be employed, in particular to meet the requirements of certain specific applications.

The comparative characteristics of different materials which can be used to constitute the refractory fillers are presented in table 1 below.

TABLE 1
physical characteristics of different materials used
to produce refractory reinforcements and fibers

| | | Silicon | |
|---|---|---|---|
| Characteristics | Carbon | carbide | Silica |
| Melting point (° C.) | >2000 | 2800 | 1700 |
| Threshold temperature | 400 (oxidizing medium) | 1400 | 900 |
| for loss of the | 2500 (neutral medium) | | |
| characteristics (° C.) | | | |
| Conductivity (W/m · K) | 100 | 25 | 1 to 2 |
| Density | 1.7 | 3.2 | 2.2 |
| Specific heat (J/kg · K) | 840 | 920 | 960 |

According to the invention, the proportions by weight of phenolic resin to refractory fillers in the organic matrix are established as follows:

Phenolic resin: 40% to 60%,

Refractory fillers (preferably SiC): 60% to 40%.

The ratio of the phenolic resin to the refractory fillers which is adopted depends, inter alia, on the particle size characteristics (median diameter D50) of the particles of refractory material. However, in a preferred embodiment, the organic matrix comprises substantially equal proportions of resin and refractory particles, the use of a 50/50 ratio making it possible to obtain a slip having rheological characteristics which are the most appropriate for the implementation of the process for the manufacture of the composite material according to the invention described in the continuation of the document.

It should be noted that, according to the invention, the proportions by weight of the two components are determined so that the contribution of refractory fillers in the resin is as high as possible, in view of, however, the miscibility limits of the filler, the maximum viscosity acceptable for use of the matrix and the need to prevent excessively rapid appearance of phenomena of separation by settling of the particles.

According to the invention, the fibrous reinforcement constituting the composition on which the composite material according to the invention is based is a structured fibrous reinforcement composed of locks in the form of loops in combination with locks in the form of unidirectional fibrils of the same nature or of a different nature.

According to the embodiment adopted, this fibrous reinforcement can be of organic nature (carbon, Kevlar), ceramic nature (silicon carbide) or mineral nature (silica). The novel structure of the fibrous reinforcement participating in the composition of the composite material according to the invention is presented diagrammatically in FIG. 2, which reinforcement is composed of a yarn 21 formed of unidirectional fibrils 22 intermingled with one another or with fibrils 23 forming loops. This “loop yarn” structure exhibits the advantage of producing a reinforcement of yarn form exhibiting, in addition to its linear yarn nature, a certain radial expansion defined by the mean diameter of the fibrils in the form of loops. This radial expansion advantageously confers a three-dimensional structure and texture on the reinforcement, the loops constituting an entanglement of fibers between two wound yarn layers.

According to the invention, the diameter and the number of the loops are defined as a function of the thickness of the composite material part to be produced.

In a preferred embodiment, use is preferably made of a fibrous reinforcement composed of a loop yarn exhibiting mainly the following characteristics:

Mean diameter of the loops: ≈5 mm,

Number of loops per meter: between 140 and 200 (preferably 160),

Ability to withstand a tensioning: ≧1.6 daN,

Application of a sizing treatment at the core and loops.

A fibrous reinforcement exhibiting such characteristics can, for example, be produced from a loop yarn made of silica fibers sold by Hexcel Fabrics under the reference “fil bouclette CB26”.

According to the invention, the proportions by volume between the organic matrix and the fibrous reinforcement are set up so that the fibrous reinforcement represents between 25% to 35% of the volume of the final material.

In addition, the proportions by weight of organic matrix and fibrous reinforcement are preferably set at 65% for the matrix and at 35% for the reinforcement, in order to obtain the desired mechanical and thermal performances.

The composition described in the preceding text is used to produce or to manufacture the composite material having fibrous reinforcement according to the invention.

In the continuation of the text, a description is given of the process employed to produce the material, this process being particularly suited to the composition described above.

The process for producing the composite material according to the invention exhibits mainly, as is illustrated in the flow diagram of FIG. 3, the following stages:

a first stage 31 of producing a “slip” (organic matrix) composed of the resin/refractory fillers mixture described above;

a second stage 32 of “filament winding” during which a loop yarn, such as that described above, is wound onto a form, for example a cylindrical mandrel, the yarn being coated with slip as it is wound onto the mandrel. The diameter and the shape of the mandrel depend here on the dimensions of the part to be protected, for example the internal diameter of the body of the thruster;

a third stage 33 during which the wound part coated with slip produced during the second stage is crosslinked at the temperature required by the resin employed;

a fourth stage 34 during which dry machining of the crosslinked part is carried out.

According to the applications under consideration, the fourth stage can be followed by an optional fifth stage during which an overwinding is carried out on the crosslinked part.

According to the invention, the first and second stages are necessarily carried out in temperature-controlled surroundings.

Furthermore, preferably, the dedicated ingredients and machinery are maintained beforehand, for a minimum period of time of approximately 20 hours preceding the preparation of the material, at a temperature within a temperature range θ between 20° C. and 30° C.

The first stage 31 of preparation of the “slip” consists in carrying out the resin/reinforcing fillers mixing.

According to the invention, this stage is preferably carried out by means of a turbine mixer, this type of mixer preferably being chosen for its performance in terms of rotational speed. This stage furthermore comprises the following operations:

an operation of weighing the phenolic resin and of introducing this resin into the bowl of the mixer;

an operation of adding, to the phenolic resin, an amount of refractory fillers corresponding, in view of the amount of phenolic resin introduced into the bowl of the mixer, to the proportions specified above regarding the organic matrix;

a mixing operation proper during which the mixer is started up. This mixing operation has a duration of approximately 30 (±5) minutes.

After the mixture has been prepared, a viscosity measurement will be carried out (Brookfield) on the “slip” thus formed, so as to monitor that the latter indeed exhibits a viscosity within the range from 8000 to 11 000 mPa·s for the working temperature range θ.

At the end of the first stage, the “slip” thus prepared is subsequently transferred, as illustrated in FIG. 4, to a tank 43 connected to a metering pump 44, a peristaltic pump, the use of which is necessary in order to carry out the second stage 32 of filament winding.

The second stage 32 of the process according to the invention consists in winding the loop yarn onto a form, for example a mandrel, the yarn being impregnated with “slip” as it is wound onto the mandrel, so as to produce a yarn preform 41 of the composite material. This stage comprises a preliminary operation of preparation of the winder, during which the positioning (alignment) of the mandrel 47 and of the spools of reinforcement yarn 21 is controlled in particular.

The rules of the art in terms of filament winding are used in order to ensure stable deposition of the fibrous reinforcement over the form (the mandrel). These rules, well known to a person skilled in the art, are not described in detail here.

According to the invention, as illustrated in FIG. 4, the loop yarn 21 is preferably packaged in the form of spools 48. It is continuously impregnated with slip 42 as it is wound onto the mandrel 47. The impregnating with “slip” is carried out by gravity, in excess, by means of a peristaltic pump 44 connected to a slip tank 43 containing the “slip” prepared on conclusion of the first stage 31 of the process.

According to the invention and in view in particular of the viscosity of the “slip”, the maximum winding speed is set at approximately 32 revolutions per minute, a speed which corresponds to the time necessary to guarantee complete impregnation of the wound loop yarn 21 by the “slip” 42.

Again according to the invention, the tension of the loop yarn 21 during the stage 32 of filament winding is maintained, by positioning and tensioning means 49, at a value of between 1.4 and 1.8 daN. A tension within such a range advantageously makes it possible to ensure the draining of the wound loop yarn 21 on the mandrel 47, so as to remove the excess slip impregnating the wound yarn, and also to ensure control of the thickness of the material produced, while avoiding the risk of the yarn 21 breaking under the action of an excessively high tension. Ideally, the tension applied is substantially equal to 1.6 daN.

As illustrated in FIG. 4, the excess “slip” produced by the draining brought about by the tensioning of the yarn is recovered by means 45 and reintroduced into its container (the tank 43) by means of a recovery circuit 46, so as to be reused for the impregnation of the yarn 21.

According to a specific embodiment, not illustrated by the figure, the spreading and impregnation of the “slip” over the entire wound yarn width on the mandrel are from time to time promoted during the winding by manual or automatic application of a gentle pressure, for example by means of a brush, or also of another type of brush formed of bristles of pure silk, with a width of 50 mm.

On conclusion of the second stage 32 of the process according to the invention, a wound preform 41 impregnated with “slip” 42 is thus obtained which is ready for the following crosslinking stage.

The third stage 33 of the process according to the invention constitutes the phase during which the wound preform 41, that is to say the organic matrix reinforced by the loop yarn 21 and formed by winding onto the mandrel 47, is subjected to a crosslinking (curing) operation which confers, on the composite material thus produced, the desired mechanical properties and also the desired thermal shielding.

As mentioned above, this crosslinking is carried out at high temperature, preferably by placing the wound preform 41 mounted on the mandrel 47 in a ventilated climate-controlled chamber (an oven) equipped with means ensuring rotation about itself of the mandrel on which the wound preform 41 is mounted.

The crosslinking operation proper is preceded by an operation of preconditioning the wound preform 41, during which preconditioning the preform is kept rotating at ambient temperature for a period of time of 8 to 12 hours.

According to the invention, the cycle of crosslinking operations which is applied to the wound preform 41 preferably takes place in five phases, as illustrated in the graph of FIG. 5:

a first phase, which follows the preconditioning operation 56, during which a temperature gradient 51 of between 20° C.±5° C. and 60° C.±5° C. is applied for substantially two hours (plus or minus 5 min),

a second phase during which a second temperature gradient 52 of between 60° C.±5° C. and 120° C.±5° C. is applied for substantially 42 hours (plus or minus 5 min);

a third phase during which a third temperature gradient 53 of between 120° C.±5° C. and 140° C.±5° C. is applied for substantially 2 hours (plus or minus 5 min);

a fourth phase of stabilization of the material during which the material is maintained at a constant temperature 54, of 140° C.±5° C., for substantially 2 hours (plus or minus 5 min);

a fifth phase, during which the temperature 55 of the crosslinked material is allowed to return to ambient temperature, the time for which depends on the natural thermal inertia of the material.

According to the invention, the second phase of the crosslinking process, which corresponds to the application of a long temperature gradient 52, of approximately 42 h, can, in a specific embodiment illustrated by the graph of FIG. 6, be split into two parts 61 and 62, in order to take account of the yield point of the resin, which characterizes the moment where the organic matrix (the “slip”) is solidified on the wound preform, and thus to limit the effects on the structure of the internal stresses brought about by the crosslinking, in particular when the polymerization is carried out only on the surface. During this phase, the thermal cycle can then describe two segments 61 and 62 within the triangular area 63.

The fourth stage 34 of the process according to the invention for its part constitutes the phase during which a final dry machining operation is carried out on the material produced, so as to confer on it the desired external diameter and the desired length. It is thus possible to obtain, as illustrated in the views 7_{—}a and 7_{—}b of FIG. 7, a shielding component 72 made of composite material which optimally matches the wall 71 for which it is responsible for ensuring the shielding, the wall of a propulsion body in the example of FIG. 7.

It should be noted that a shielding component, such as that illustrated by FIG. 7, for example, can be produced by producing a yarn preform by winding onto a conical mandrel.

The physical and thermomechanical characteristics of the composite material thus obtained are presented in table 2 below.

TABLE 2
ranges of the characteristics of a composite
material according to the invention

| Performances measured | Material described in the invention |
|---|---|
| Thermal diffusivity (α) (mm²/s) | 0.4 to 0.7 between 20° C. and |
| | 1000° C. |
| Specific heat (Cp) (J/g · K) | 0.8 to 1.4 between 20° C. and |
| | 1000° C. |
| Elongation (%) | 0.26 ± 0.01 |
| Density | 1.7 ± 0.1 |
| Young's modulus (MPa) | 11 000 ± 1000 |

It should be noted that, following the requirements of the final applications envisaged, the final stage of the process according to the invention can be followed by an additional stage 35 of overwinding applied to the preprepared heat shield. This overwinding operation can be carried out by means of a yarn reinforcement preimpregnated with a resin chemically compatible with that employed to prepare the composite material, preferably a phenolic resin, the fibers of the yarn reinforcement contributing better longitudinal mechanical strength to the final part. The yarn is here a yarn made of carbon fiber.

It should also be noted that, following the requirements of the final applications envisaged, the final stage of the process according to the invention can comprise an operation which consists in filling in the open porosities present on the internal surface of the composite material, for example by means of a gel coat.

The continuation of the description presents, by way of illustration of the present invention, two examples of composite materials corresponding to the invention.

A first example of implementation of the invention consists of a composite material prepared from a “slip” exhibiting a composition by weight equal to 50% of phenolic resin RA101 and 50% of 11 m²/g silicon carbide.

After homogenizing the mixture, the slip thus composed, exhibiting a viscosity of 8000 to 11 000 mPa·s, is transferred to the winding plant, where it is deposited continuously and in excess on a metal mandrel around which a filament winding of fibrous silica reinforcements is being carried out, the fibrous silica reinforcements forming a yarn exhibiting loop locks in a proportion of 160 loops per linear meter of yarn.

In this first example, the composite material finally obtained after crosslinking, by use of the process described above, exhibits a matrix/fibrous reinforcement ratio by volume of 40/40, the remainder of the volume occupied by the material (20% of the volume) being composed of the natural porosity of the material.

The thermodynamic characteristics of such a material component forming a heat shield thermal shielding with a thickness of 7 mm, a diameter of 350 mm and a length of 1 m are presented in table 3 below, which characteristics are measured during a test campaign.

| Performances measured | Example 1 |
|---|---|
| Thermal diffusivity (α) (mm²/s) | 0.4 to 0.7 between 20° C. and |
| | 1000° C. |
| Specific heat (Cp) (J/g · K) | 0.8 to 1.4 between 20° C. and |
| | 1000° C. |
| Elongation (%) | 0.26 ± 0.01 |
| Density | 1.7 ± 0.1 |
| Young's modulus (MPa) | 11 000 ± 1000 |
| % Erosion following engine test | 0 mm |
| (φ = 350 mm) | |

Table 3: characteristics of the material of the first implementational example described above

A second example of implementation of the invention consists of a composite material forming a PDMS variant for thermal shielding prepared by means of the filament winding process as described above. The organic matrix consists here of a polymeric resin of silicone resin type functioning with regard to a polymerization method of polyaddition type. The material is here produced from a “slip” exhibiting a composition by weight equal to 110 parts by weight of silicone resin of RTV 630 type and 10 parts by weight of Orkla silicon carbide fillers.

After homogenizing the mixture, the slip, exhibiting a viscosity of 50 000 mPa·s, is transferred to the winding plant where it is deposited, by the wet route, continuously and in excess, on a mandrel around which a filament winding of fibrous silica reinforcements is being carried out, the fibrous silica reinforcements forming a yarn exhibiting loop locks in a proportion of 160 loops per linear meter of yarn.

In this second example, the composite material finally formed, after carrying out the process described above, exhibits, after crosslinking at 65° C., a matrix/fibrous reinforcement ratio by volume of 60/40.

The thermodynamic characteristics of such a material component forming a heat shield thermal shielding with a thickness of 7 mm, a diameter of 100 mm and a length of 0.3 m are presented in table 4 below, which characteristics are measured during a test campaign.

| Performances measured | Example 2 |
|---|---|
| Thermal diffusivity (α) (mm²/s) | 0.15 < α < 0.9 between 20° C. and |
| | 1000° C. |
| Specific heat (Cp) (J/g · K) | 0.5 < Cp < 2 between 20° C. and |
| | 1000° C. |
| Elongation (%) | 8 |
| Density | 1.8 |
| Young's modulus (Mpa) | 85 |
| % Erosion following engine test | 0 mm |
| (φ = 100 mm) | |

Table 4: characteristics of the second implementational example described above.

1. A composite material formed by crosslinking a thermosetting organic matrix impregnated into a reinforcement composed of mineral fibers or ceramic fibers, the matrix being predominantly composed of a liquid resin to which refractory reinforcing fillers are added,
wherein, the fibrous reinforcement being composed of a yarn exhibiting, over its entire length, fibers forming protruding loops, the composite material is produced by winding the yarn onto a mandrel and by impregnating the wound yarn with organic matrix, so as to form a wound preform impregnated with organic matrix exhibiting the desired final geometry; the wound preform subsequently being crosslinked in an oven so as to form the final composite material; the winding of the preform being carried out so that, in view of the composition of the organic matrix and of the nature and constitution of the yarn forming the fibrous reinforcement, the organic matrix and the fibrous reinforcement are present in the material obtained, after crosslinking in an oven, in the following proportions by volume:
between 65% and 75% of organic matrix,
between 25% and 35% of fibrous reinforcements.

2. A composition for producing a composite material as claimed in claim 1, further comprising a thermosetting organic matrix composed of a liquid resin comprising refractory particles as filler and also a fibrous reinforcement composed of a yarn formed of fibers, some fibers forming protruding loops over the entire length of the yarn, the thermosetting organic matrix impregnating the fibrous reinforcement.

3. The composition as claimed in claim 2, characterized in that the fibrous reinforcement is composed of silica (SiO₂) or silicon carbide (SiC) fibers.

4. The composition as claimed in claim 2, wherein the fibrous reinforcement made of silica exhibits a number of loops per linear meter of between 140 and 200.

5. The composition as claimed in claim 2, wherein the loops of the fibrous reinforcement exhibit a mean diameter of 5 mm.

6. The composition as claimed in claim 2, wherein the filler-comprising organic matrix is a mixture comprising an aqueous phenolic resin and refractory particles, the proportions by weight between the phenolic resin and the refractory fillers being within the following ranges:
40 to 60% of phenolic resin;
60 to 40% of refractory fillers.

7. The composition as claimed in claim 6, wherein the filler-comprising organic matrix comprises, by weight, 50% of phenolic resin and 50% of refractory filler.

8. The composition as claimed in claim 6, wherein the phenolic resin is a liquid resin of resol type.

9. The composition as claimed in claim 8, wherein the refractory fillers are composed of silicon carbide.

10. The composition as claimed in claim 9, wherein the refractory fillers made of silicon carbide are of substantially spherical shape and exhibit a median diameter of between 12 μm and 20 μm.

11. The composition as claimed in claim 9, wherein the silicon carbide comprises boron as flux.

12. The composition as claimed in claim 2, wherein the filler-comprising organic matrix is a mixture comprising a resin and refractory particles, the resin being a silicone oil for which the method of polymerization is of the polyaddition type.

13. A process for manufacturing a composite material component from the composition as claimed in claim 2, the component having a form defined by a tubular mandrel, wherein, the machinery and starting materials being brought beforehand to an ambient temperature of between 20° C. and 30° C., the process comprises mainly the following stages:
a first stage of producing the mixture, or “slip”, between the resin and the refractory filler, the mixture being produced at ambient temperature;
a second stage of filament winding, during which stage the fibrous reinforcement of yarn structure is wound, according to a preestablished winding cycle, onto the rotating mandrel while it is impregnated with the “slip”, the deposition of the “slip” being carried out continuously; the winding, carried out at ambient temperature, producing a preform made of wound yarn, which preform is impregnated with slip;
a third stage of crosslinking the preform impregnated with “slip”, the crosslinking being carried out according to a sequence of different temperature steps having increasing values; the third stage being terminated by a phase during which the crosslinked material is allowed to return, of its own accord, to ambient temperature;
a fourth stage of dry machining which makes it possible both to release the crosslinked part from the mandrel and to obtain the dimensions desired for the composite material component.

14. The process as claimed in claim 13, wherein, before carrying out the first stage, the machinery and the starting materials are brought to ambient temperature and are maintained at this temperature for a minimum stabilization time of approximately 20 hours.

15. The process as claimed in claim 13, wherein the first stage employs a turbine mixer configured in order to obtain a resin/refractory fillers mixture for which the Brookfield viscosity is on between 8000 mPa·s and 11 000 mPa·s.

16. The process as claimed in claim 13, wherein, during the second stage, the deposition of the “slip” on the wound yarn reinforcement is carried out continuously and in excess by means of a peristaltic pump connected to a tank containing the prepared “slip”.

17. The process as claimed in claim 16, wherein the spreading of the “slip” at the surface of the wound yarn reinforcement is associated with the application of a gentle pressure by means of a brush.

18. The process as claimed in claim 13, wherein the second stage of filament winding comprises the following preliminary operations:
preparation of the winder and positioning of the mandrel and spools of fibrous reinforcement;
adjusting the tension yarn forming the fibrous reinforcement, to a value which makes it possible to ensure the draining of the yarn reinforcement during winding so as to remove the slip deposited in excess on the yarn reinforcement, without risk of breaking the yarn reinforcement;
adjusting the maximum winding rate to a value which makes possible complete impregnation of the wound reinforcement by the “slip”.

19. The process as claimed in claim 16, wherein the tension applied to the yarn reinforcement is between 1.4 and 1.8 daN and that the rotational speed of the mandrel is approximately 32 revolutions per minute.

20. The process as claimed in claim 19, wherein the tension applied to the yarn reinforcement is 1.6 daN.

21. The process as claimed in claim 18, wherein the excess “slip” recovered by the draining resulting from the tension applied to the yarn constituting the yarn reinforcement is reintroduced into the “slip” tank.

22. The process as claimed in claim 13, wherein the third stage of temperature crosslinking the yarn preform is carried out according to the following cycle:
application of a first temperature gradient of between 20° C.±5° C. and 60° C.±5° C. during the first 2 hours±5 min;
application of a second temperature gradient of between 60° C.±5° C. and 120° C.±5° C. for the following 42 hours±5 min;
application of a third temperature gradient of between 120° C.±5° C. and 140° C.±5° C. over a period of time of 23 hours±5 min;
maintenance at the stabilization temperature of 140° C.±5° C. for 2 hours±5 min;
return to ambient temperature according to the natural inertia cycle of the material;
the third stage being carried out while the yarn preform is kept rotating.

23. The process as claimed in claim 13, further comprising an additional stage of overwinding.

24. The process as claimed in claim 23, wherein the overwound material employed is composed of a yarn of organic fibers which is preimpregnated with a resin chemically compatible with that employed to produce the composite material proper.

25. The process as claimed in claim 24, wherein the overwound material employed is composed of a yarn of carbon fibers which is preimpregnated with a phenolic resin.
